(19) United States
(12) Patent Application Publication
(10) Pub. No.: US 2004/0226014 A1
(43) Pub. Date: Nov. 11, 2004

(54) System and method for providing balanced thread scheduling

(76) Inventor: Mark Justin Moore, Cambridge (GB)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/746,293

(22) Filed: Dec. 29, 2003

Related U.S. Application Data
(60) Provisional application No. 60/437,062, filed on Dec. 31, 2002.

(51) Int. Cl. G06F 9/46

(52) U.S. Cl. 718/100

(57) ABSTRACT

A system, method and computer-readable medium for providing balanced thread scheduling initially comprise assigning a thread energy level to each of a plurality of system threads. At least one of the plurality of system threads is provided with at least one message, wherein the at least one message is assigned a message energy level lower than the thread energy level for the thread from which the message originated. A message is then passed between a first thread and a second thread wherein the message energy level assigned to the passed message is also passed between the first thread and the second thread and wherein the message energy level is proportionate to a quantifiable amount of CPU resources.

### CROSS-REFERENCE TO RELATED APPLICATIONS

The present application claims priority to co-pending U.S. Provisional Patent Application No. 60/437,062, filed Dec. 31, 2002, the entirety of which is incorporated by reference herein.

### BACKGROUND OF THE INVENTION

The present invention relates generally to the field of computer systems and, more particularly, to systems for scheduling process execution to provide optimal performance of the computer system.

The operation of modern computer systems is typically governed by an operating system (OS) software program which essentially acts as an interface between the system resources and hardware and the various applications which make requirements of these resources. Easily recognizable examples of such programs include Microsoft Windows™, UNIX, DOS, VxWorks, and Linux, although numerous additional operating systems have been developed for meeting the specific demands and requirements of various products and devices.

In general, operating systems perform the basic tasks which enable software applications to utilize hardware or software resources, such as managing I/O devices, keeping track of files and directories in system memory, and managing the resources which must be shared between the various applications running on the system. Operating systems also generally attempt to ensure that different applications running at the same time do not interfere with each other and that the system is secure from unauthorized use.

Depending upon the requirements of the system in which they are installed, operating systems can take several forms. For example, a multi-user operating system allows two or more users to run programs at the same time. A multiprocessing operating systems supports running a single application across multiple hardware processors (CPUs). A multitasking operating system enables more than one application to run concurrently on the operating system without interference. A multithreading operating system enables different parts of a single application to run concurrently. Real time operating systems (RTOS) execute tasks in a predictable, deterministic period of time. Most modern operating systems attempt to fulfill several of these roles simultaneously, with varying degrees of success.

Of particular interest to the present invention are operating systems which optimally schedule the execution of several tasks or threads concurrently and in substantially real-time. These operating systems generally include a thread scheduling application to handle this process. In general, the thread scheduler multiplexes each single CPU resource between many different software entities (the ‘threads’) each of which appears to its software to have exclusive access to its own CPU. One such method of scheduling thread or task execution is disclosed in U.S. Pat. No. 6,108,683 (the '683 patent). In the '683 patent, decisions on thread or task execution are made based upon a strict priority scheme for all of the various processes to be executed. By assigning such priorities, high priority tasks (such as video or voice applications) are guaranteed service before non critical or real-time applications. Unfortunately, such a strict priority system fails to address the processing needs of lesser priority tasks which may be running concurrently. Such a failure may result in the time-out or shut down of such processes which may be unacceptable to the operation of the system as a whole.

Another known system of scheduling task execution is disclosed in U.S. Pat. No. 5,528,513 (the '513 patent). In the '513 patent, decisions regarding task execution are initially made based upon the type of task requesting resources, with additional decisions being made in a round-robin fashion. If the task is an isochronous, or real-time task such as voice or video transmission, a priority is determined relative to other real-time tasks and any currently running general purpose tasks are preempted. If a new task is a general purpose or non-real-time task, resources are provided in a round robin fashion, with each task being serviced for a set period of time. Unfortunately, this method of scheduling task execution fails to fully address the issue of poor response latency in implementing hard real-time functions. Also, as noted above, extended resource allocation to real-time tasks may disadvantageously result in no resources being provided to lesser priority tasks.

Accordingly, there is a need in the art of computer systems for a system and method for scheduling the execution system processes which is both responsive to real-time requirements and also fair in its allocation of resources to non-real-time tasks.

### SUMMARY OF THE INVENTION

The present invention overcomes the problems noted above and realizes additional advantages, by providing a system and method for balancing thread scheduling in a communications processor. In particular, the system of the present invention allocates CPU time to execution threads in a real-time software system. The mechanism is particularly applicable to a communications processor that needs to schedule its work to preserve the quality of service (QoS) of streams of network packets. More particularly, the present invention uses an analogy of “energy levels” carried between threads as messages are passed between them, and so differs from a conventional system wherein priorities are assigned to threads in a static manner. Messages passed between system threads are provided with associated energy levels which pass with the messages between threads. Accordingly, CPU resources allocated to the threads vary depending upon the messages which they hold, thus ensuring that the handling of high priority messages (e.g., pointers to network packets, etc.) is affording appropriate CPU resources throughout each thread in the system.

### BRIEF DESCRIPTION OF THE DRAWINGS

The present invention can understood be more completely by reading the following Detailed Description of the Preferred Embodiments, in conjunction with the accompanying drawings.

FIG. 1 is a high-level block diagram illustrating a computer system 100 for use with the present invention.

FIG. 2 is a flow diagram illustrating one embodiment of the thread scheduling methodology of the present invention.

FIGS. 3a-3d are a progression of generalized block diagram illustrating one embodiment of a system 300 for scheduling thread execution in various stages.

### DETAILED DESCRIPTION OF THE PREFERRED EMBODIMENTS

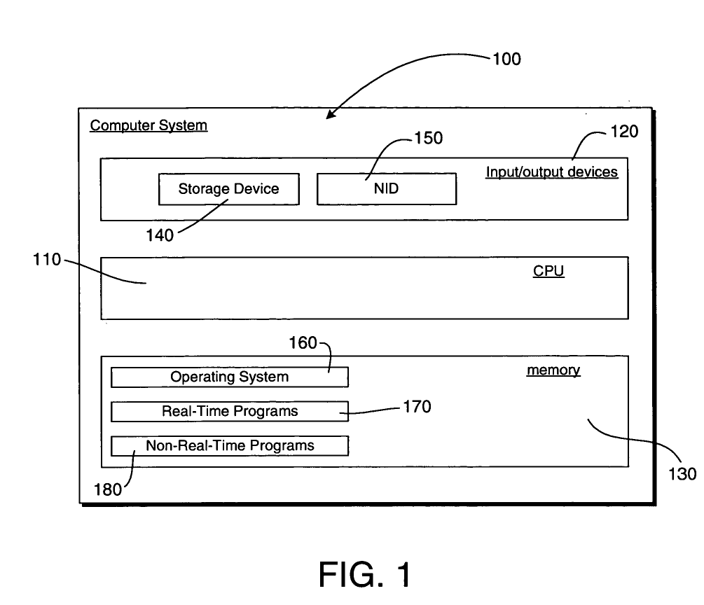

Referring now to the Figures and, in particular, to FIG. 1, there is shown a high-level block diagram illustrating a computer system 100 for use with the present invention. In particular, computer system 100 includes a central processing unit (CPU) 110, a plurality of input/output (I/O) devices 120, and memory 130. Included in the plurality of I/O devices are such devices as a storage device 140, and a network interface device (NID) 150. Memory 130 is typically used to store various applications or other instructions which, when invoked enable the CPU to perform various tasks. Among the applications stored in memory 130 are an operating system 160 which executes on the CPU and includes the thread scheduling application of the present invention. Additionally, memory 130 also includes various real-time programs 170 as well as non-real-time programs 180 which together share all the resources of the CPU. It is the various threads of programs 170 and 180 which are scheduled by the thread scheduler of the present invention.

Generally, the system and method of the present invention allocates CPU time to execution threads in a real-time software system. The mechanism is particularly applicable to a communications processor that needs to schedule its work to preserve the quality of service (QoS) of streams of network packets. More particularly, the present invention uses an analogy of “energy levels” carried between threads as messages are passed between them, and so differs from a conventional system wherein priorities are assigned to threads in a static manner.

As set forth above, the environment of the present invention is a communications processor running an operating system having multiple execution threads. The processor is further attached to a number of network ports. Its job is to receive network packets, identify and classify them, and transfer them to the appropriate output ports. In general, each packet will be handled in turn by multiple software threads, each implementing a protocol layer, a routing function, or a security function. Examples of suitable threads would include IP (Internet Protocol), RFC1483, MAC-level bridging, IP routing, NAT (Network Address Translation), and a Firewall.

Within the system, each thread is assigned an particular “energy level”. Threads are then granted CPU time in proportion to their current energy level. In a preferred embodiment, thread energy levels may be quantized when computing CPU timeslice allocation to reduce overhead in the timeslice allocator, however this feature is not required.

In accordance with the present invention, total thread energy is the sum of all static and dynamic components. The static component is assigned by the system implementers, defining the timeslice allocation for an isolated thread that does not interact with other system entities, whereas the dynamic component is determined from run-time interactions with other threads or system objects.

Additionally, threads interact by means of message passing. Each message sent or received conveys energy from or to a given thread. The energy that is conveyed through each interaction is a programmable quantity for each message, normally configured by the implementers of a given system. Interacting threads only affect each other's allocation of CPU time—other unrelated threads in the system continue to receive the same execution QoS. In other words, if thread A has 2% and thread B has 3% of the system's total energy level, they together may pass a total of 5% of the CPU's resources between each other through message passing. In this way, their interaction does not affect other running threads or system processes. In a communications processor such as that associated with the present invention, there is a close correlation between messages and network packets since messages are used to convey pointers to memory buffers containing the network packets.

Messages interactions with external entities such as hardware devices (e.g.: timers or DMA (Direct Memory Access) engines) or software entities (e.g., free-pools of messages) provide analogous energy exchange. In another embodiment of the present invention, a thread incurs an energy penalty when a message is allocated. This penalty is then returned when the message is eventually freed (i.e., returned to the message pool). If a thread blocks to wait for a specific message to be returned, its entire energy is passed to the thread currently holding the message. If no software entity holds the specific message (as is the case, for example, in interactions with interrupt driven hardware devices such as timers), or if the thread waits for any message, the entire thread energy is shared evenly between other non-blocked threads in the system.

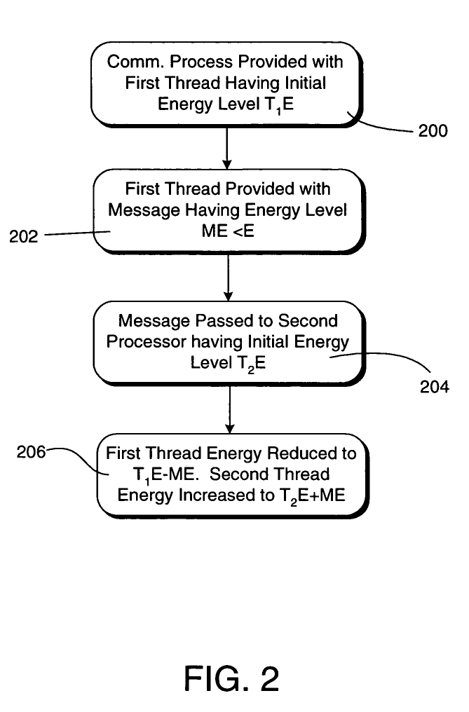

Referring now to FIG. 2, there is shown a flow diagram illustrating one embodiment of the thread scheduling methodology of the present invention. In step 200, a communications process is provided with a first threads, having an initial assigned energy level T₁E. In step 202 the threads is provided with a message, the message having an energy level ME<T₁E. In step 204, is the message is passed to a second thread having initial energy T₂E, along with its energy level. This results in a corresponding reduction in the first thread's energy level to T₁E−ME and a corresponding increase in the second thread's energy level to T₂E+ME in step 206.

This scheme is similar in operation to a weighted fair queuing system but with the additional feature that interacting threads do not, as a side effect, impact the execution of other unrelated threads. This is an important property for systems dealing with real-time multi-media data. The techniques described may be extended to cover most conventional embedded OS system operations such as semaphores or mutexes by constructing these from message exchange sequences.

The important properties of this system are that its behaviour corresponds to that needed to transfer network packets of different priority levels. Conversely, it avoids some of the undesirable effects that occur under heavy load when a more conventional priority-based thread scheduling system is used in a communications processor. For example, a thread which has a queue of messages to process will have a high energy level associated therewith (since each message will have a discrete energy level), so will receive a larger share of CPU time, enabling it to catch up. Specifically, this helps to avoid the buffer starvation problem which can occur with a conventional priority scheduling system under heavy load. In this scenario, if all the buffers are queued up on a particular thread, then incoming network packets may have to be discarded simply because there are no free buffers left to receive them. More generally, the tendency will be to allocate the CPU time to points of congestion in the system, and towards freeing resources for which are blocking other threads from continuing execution.

In another example, an incoming packet can be classified soon after arrival, and an appropriate energy level assigned to its buffer/message. The assigned energy level is then carried with the packet as it makes its way through the system. Accordingly, a high-priority packet will convey its high energy to each protocol thread in turn as it passes through the system, and so should not be unduly delayed by other, lower-priority, traffic. In real-time embedded systems requiring QoS guarantees, the present invention's ability to provide such guarantees substantially improves performance.

The following examples assume that the operating system interface includes the following system calls:

| | |
|---|---|
| SendMessage(MsgId, ThreadId) | Send message MsgId to thread |
| | ThreadId, and continue execution of |
| | current thread. |
| AwaitMessage( ) | Suspend current thread until any |
| | message arrives. |
| AwaitSpecificMessage(MsgId) | Suspend current thread until the specific |
| | message MsgId returns. (Any other |
| | messages arriving in the meantime are |
| | queued for collection later.) |

In accordance with the present invention, the control data structures for each thread and each message are configured to contain a field indicating the currently assigned energy level.

Sending a Message

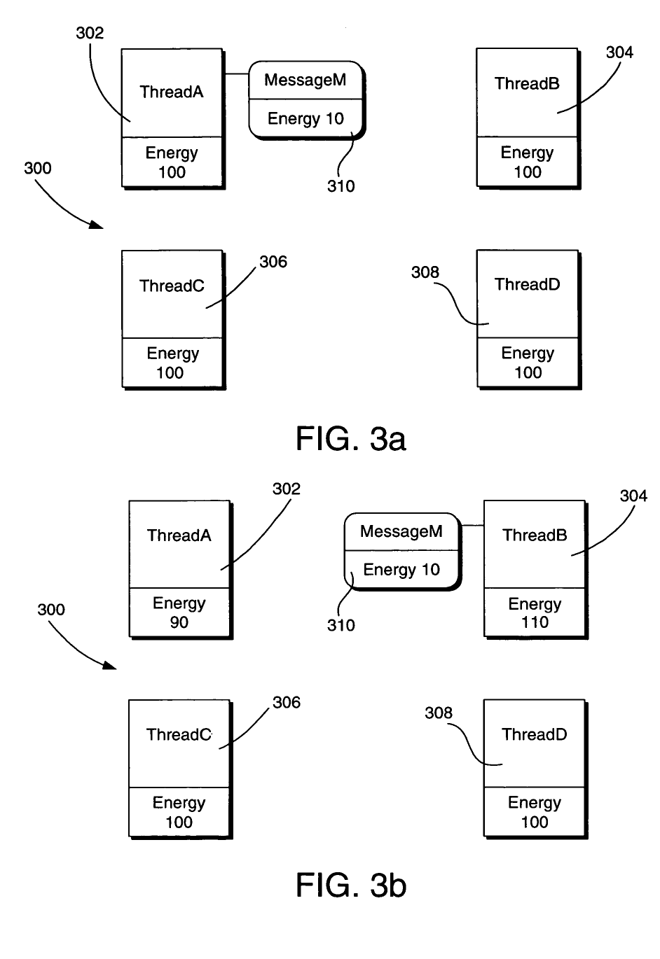

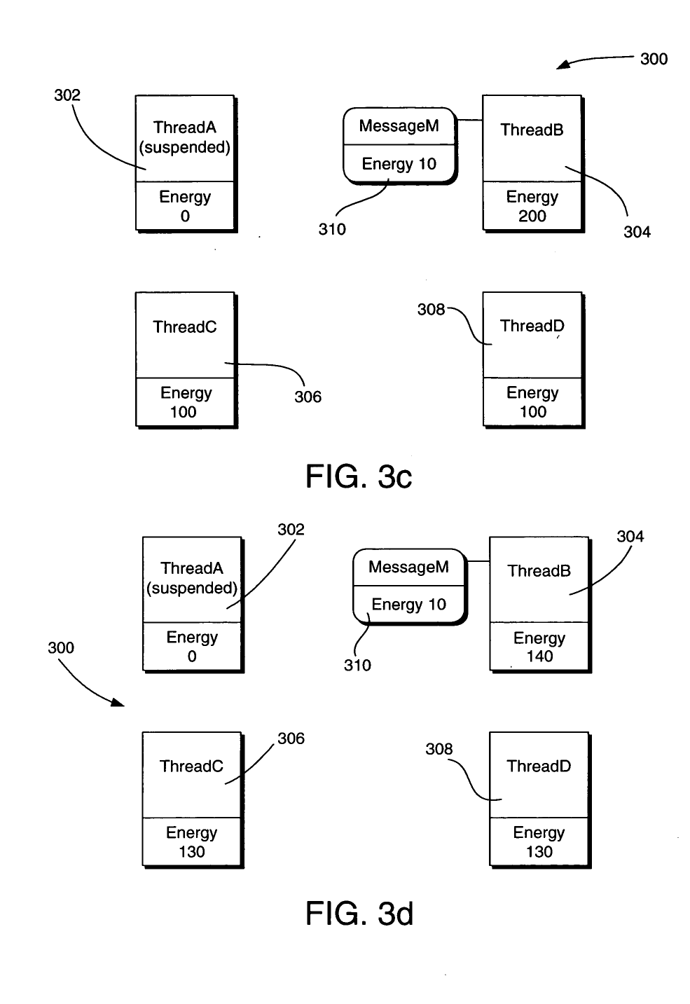

Referring now to FIGS. 3a-3d, there is shown a progression of generalized block diagram illustrating one embodiment of a system 300 for scheduling thread execution in various stages. Initally, as shown in FIG. 3a, the system is provided with four threads, ThreadA 302, ThreadB 304, ThreadC 306 and ThreadD 308, each of which start at an energy level of 100 units (and so will receive equal proportions of the CPU time—one quarter each). ThreadA 302 currently owns message MessageM 310 having an energy level of 10 units (included in ThreadA's 100 total units).

Referring now to FIG. 3b, ThreadA 302 then sends MessageM 310 to ThreadB 304 (which will eventually return it), for additional processing. Accordingly, ThreadB 304 has been passed the 10 units of energy associated with MessageM 310 and previously held by ThreadA 302. ThreadA 302 now as 90 units and ThreadB 304 110 units, resulting in ThreadB receiving a higher proportion of the CPU time.

Waiting for a Specific Message

Referring now to FIG. 3c, after the situation in FIG. 3b, ThreadA 302 then calls the function call AwaitSpecificMessage( ) to suspend itself until MessageM 310 returns. Correspondingly, all of ThreadA's remaining energy is passed to ThreadB 304, resulting in 0 units of energy for ThreadA and 200 units of energy for ThreadB. ThreadB 304 now receives half of the total CPU time, until it finishes processing the message and returns it to ThreadA 302.

Waiting for Any Message

Referring now to FIG. 3d, another possible continuation from the situation in FIG. 3b is that ThreadA 302 waits for any message (rather than a specific message). In this scenario, ThreadA 302 calls the function call AwaitMessage( ), thereby suspending itself until any message (not necessarily MessageM 310) arrives. In this circumstance, all of ThreadA's remaining 90 units of energy are then shared equally among the three running threads (ThreadB—140; ThreadC—130; ThreadD—130). In this scenario, the three running threads now get about one third of the CPU time each, with ThreadB 304 getting slightly more while it has MessageM 310, although this amount is passed along with MessageM 310.

It should be understood that the above scenarios are overly simplistic for explanation purposes only. Actual implementation of the methodology of the present invention would involve substantially more threads, function calls, and messages, each of which may have ramifications on the energy levels assigned and passed between the threads.

What is claimed is:

1. A method for providing balanced thread scheduling, comprising:
assigning a thread energy level to each of a plurality of system threads;
providing at least one of the plurality of system threads with at least one message, wherein the at least one message is assigned a message energy level lower than the thread energy level for the thread from which the message originated; and
passing a message between a first thread and a second thread wherein the message energy level assigned to the passed message is also passed between the first thread and the second thread, wherein the message energy level is proportionate to a quantifiable amount of CPU resources.

2. The method of claim 1, wherein the plurality of messages are initially allocated to requesting threads from a free message pool.

3. The method of claim 2, wherein return of a message to the free message pool, returns the message energy level of the returned message to the initially requesting thread.

4. The method of claim 1, further comprising:
suspending the first thread following message passage to the second thread; and
passing all of the first thread's remaining energy level to the second thread.

5. The method of claim 1, further comprising:
suspending the first thread following message passage to the second thread; and
passing all of the first thread's remaining energy level evenly between each remaining thread.

6. A system for providing balanced thread scheduling, comprising:
memory for storing an operating system, at least one application; and
a central processing unit (CPU) for executing the operating system, the at least one application, and a plurality of threads associated with the at least one application,
wherein the operating system assigns a thread energy level to each of the plurality of threads,
wherein the operating system provides at least one of the plurality of threads with at least one message,
wherein the at least one message is assigned a message energy level lower than the thread energy level for the thread from which the message originated; and
wherein the operating system passes a message between a first thread and a second thread such that the message energy level assigned to the passed message is also passed between the first thread and the second thread.

7. The system of claim 5, wherein the plurality of messages are initially allocated to requesting threads from a free message pool.

8. The system of claim 7, wherein return of a message to the free message pool, returns the message energy level of the returned message to the initially requesting thread.

9. The system of claim 6, wherein the operating system suspends the first thread following message passage to the second thread and passes all of the first thread's remaining energy level to the second thread.

10. The system of claim 6, wherein the operating system suspends the first thread following message passage to the second thread and passes all of the first thread's remaining energy level evenly between each remaining thread.

11. A computer-readable medium incorporating instructions for enabling balanced thread scheduling, comprising:
one or more instructions for assigning a thread energy level to each of a plurality of system threads;
one or more instructions for providing at least one of the plurality of system threads with at least one message, wherein the at least one message is assigned a message energy level lower than the thread energy level for the thread from which the message originated; and
one or more instructions for passing a message between a first thread and a second thread wherein the message energy level assigned to the passed message is also passed between the first thread and the second thread, wherein the message energy level is proportionate to a quantifiable amount of CPU resources.

12. The computer-readable medium of claim 11, further comprising one or more instructions for initially allocating the plurality of messages to requesting threads from a free message pool.

13. The computer-readable medium of claim 12, wherein return of a message to the free message pool, also returns the message energy level of the returned message to the initially requesting thread.

14. The computer-readable medium of claim 11, further comprising:
one or more instructions for suspending the first thread following message passage to the second thread; and
one or more instructions for passing all of the first thread's remaining energy level to the second thread.

15. The computer-readable medium of claim 11, further comprising:
one or more instructions for suspending the first thread following message passage to the second thread; and
one or more instructions for passing all of the first thread's remaining energy level evenly between each remaining thread.
